(19) United States
(12) Patent Application Publication
(10) Pub. No.: US 2008/0203755 A1
(43) Pub. Date: Aug. 28, 2008

(54) INTERIOR TRIM ELEMENT

(76) Inventors: Jean-marie Bourgeois-Jacquet, Ronchin (FR); Francois Nelias, Croix (FR)

Correspondence Address: FRASER CLEMENS MARTIN & MILLER LLC, 28366 KENSINGTON LANE, PERRYSBURG, OH, 43551, US

(21) Appl. No.: 12/035,093

(22) Filed: Feb. 21, 2008

(30) Foreign Application Priority Data
Feb. 23, 2007 (FR) 07 53455

(51) Int. Cl. B60J 3/00

(52) U.S. Cl. 296/97.5

(57) ABSTRACT

An interior trim element provided with a display device and a method for producing such an element is disclosed. The interior trim element includes a substrate, an intermediate layer of foam material and a covering skin. It integrates the display device by means of backlighting a facing, the projection of which is shown on a display area of the covering skin. The interior trim element further includes a light box of the display device at least partly fitted into a corresponding receiving mount arranged in the substrate and the layer of intermediate material and extending up to the internal surface of the relevant display area of the skin, and in that a sheet of semi-rigid material is attached, directly or with the interposition of the facing, onto the internal face of the display area.

### CROSS-REFERENCE TO RELATED APPLICATION

This application claims the benefit of French patent application serial no. 07 53455 filed Feb. 23, 2007, hereby incorporated herein by reference in its entirety.

### FIELD OF THE INVENTION

The present invention relates to the field of displaying or selectively showing graphic shapes, alphanumeric data and more generally visible objects for information or decorative purposes, on a visible surface or surfaces of an interior trim element or interior lining, in particular in motor vehicles. The invention relates more particularly, but not in a restricted manner, to a dashboard of a motor vehicle comprising display areas integrated into the structure forming the dashboard panel.

### BACKGROUND OF THE INVENTION

The dashboards of motor vehicles consist of complex elements and unite together a large diversity of functions.

One of the essential functions or even the essential function of this interior part of the motor vehicle is to inform the driver, and additionally the front passenger, about the general state of the vehicle, the status of certain functions or significant parameters connected to the functioning drive and the safety of the vehicle, external conditions outside the vehicle and the status of functions or factors affecting the comfort of the passengers and the environment and internal conditions of the interior.

This increase in the amount of information to be displayed has required the reorganization and hierarchization of the display and signaling means integrated into dashboards.

The latter generally have a composite structure comprising a substantially rigid support substrate, an intermediate layer of material with a specific thickness which extends over a surface section of at least one surface of said substrate and a covering skin covering the visible surfaces of the layer of intermediate material and the substrate.

Thus in current vehicles, the display of specific information about status, in one or more states, is performed in a manner which is offset in relation to the display devices and main dashboard instruments, in cut-outs in the surface of the dashboard provided with glass-covered facades on which information is displayed, for example by backlighting. This type of display makes it possible to avoid the permanent display of a piece of information, which is only occasionally relevant to attract attention as an easily perceptible light signal and/or to facilitate the identification of information in low lighting conditions.

However, this known solution changes the aesthetic appearance of the dashboard, creates zones of preferential reflection, but still allows information to appear in normal lighting conditions, generates areas under stress and/or weakened areas in the surface of the board and requires very good quality finishing at the joining interface between the screen and the skin of the surface of the dashboard.

To overcome these limitations it has been proposed to integrate into the said dashboard at least one device for the selective display in at least one area of the skin of at least one piece of information, a symbol or similar visual object. Said devices consist essentially on the one hand of a light box integrating at least one light source and on the other hand a facing arranged to be illuminated by the said light source, the projection of which is directed towards the corresponding associated display area of the skin.

An embodiment of this type is described in document FR-A-2 824 510. However, as the projection of information takes place though a substantial thickness of foam, there is a significant diffusion of light downstream of the facing, resulting in blurred and imprecise contours of the visual object projected on the surface of the dashboard.

From document U.S. Pat. No. 6,652,128 a device of the aforementioned type is also known, more particularly in association with a push-button mechanism.

In the various different embodiments described in this document the illuminated zone is a weakened area (absence of a support layer for the visible layer of material), or perforated.

Moreover, the associated lighting means has a complex structure, in particular has multiple components, which results in complicated assembly processes in situ.

Lastly, from document JP-A-503 89 68 a dashboard integrating a unit of backlit dashboard instruments is known.

The transparent board showing the information displayed by backlighting is covered at the front by an anti-reflective material, which is stabilized in dimensional terms by a transparent anti-distortion sheet.

However, the backlit unit disclosed in this document is not integrated mechanically into the structure of the dashboard and the optical transmission qualities of the covering material are not specified.

The aim of the present invention is to overcome the disadvantages and limitations of the existing solutions mentioned above.

### SUMMARY OF THE INVENTION

Concordant and consistent with the present invention an interior trim element methods for producing an interior trim element for a dashboard of a motor vehicle, wherein the disadvantages and limitations of the existing solutions are overcome, has surprisingly been discovered.

In one embodiment, an interior trim element for a motor vehicle comprises a support substrate; a layer of intermediate material extending over at least a surface of the substrate; a covering skin covering visible surfaces of the layer of intermediate material and the substrate; and a display device disposed adjacent the covering skin, the display device including a light box having a light source and a facing arranged so to be illuminated by the light source, wherein a projection of the facing is directed towards a display area of the skin to selectively display a visual object.

In another embodiment, An interior trim element for a motor vehicle comprises a support substrate; a layer of intermediate material extending over at least a surface of the substrate; a covering skin covering visible surfaces of the layer of intermediate material and the substrate; a display device disposed adjacent the covering skin, the display device including a light box having a light source and a facing arranged so to be illuminated by the light source, wherein a projection of the facing is directed towards a display area of the skin to selectively display a visual object; a receiving mount disposed in the substrate and the layer of intermediate material, extending to an internal surface of the display area and adapted to receive the display device; and a sheet formed from semi-rigid material having a desired transparency disposed adjacent the internal surface of the display area.

The invention also provides methods for producing an interior trim element for a dashboard of a motor vehicle.

One method comprises the steps of providing a mold having a lower part and an upper part; disposing a skin in the lower part of the mold; disposing a facing and a semi-rigid sheet supporting the facing on at least one of a level of an area of the skin designed to form a display area and an insert fixed onto the upper part of the mold; disposing a support substrate on at least one of the lower mold and the upper mold, the support substrate including a pre-shaped sheet having at least one traversing opening, closing the mold by closing the lower part and the upper part, the upper part including at least one insert which during closure passes through the corresponding opening in the substrate, injecting an intermediate material into a space formed between the skin and the substrate; opening the mold and removing the molded interior trim element; and performing a finishing operation for completing the assembly of a light box including at least one light source and the facing arranged so as to be illuminated by the light source, wherein a projection of the facing is directed towards a corresponding associated display area of the skin.

### BRIEF DESCRIPTION OF THE DRAWINGS

The invention is explained in more detail in the following with reference to preferred embodiments, given as non-restrictive examples, and explained with reference to the attached schematic drawings in which:

FIG. 1 is a schematic cross section of an interior trim element according to the invention;

FIG. 2 is a schematic localized and more detailed cross section of the element of FIG. 1, according to a first variant of a first embodiment of the invention;

FIG. 3 is a similar view to that of FIG. 2 of a second variant of a first embodiment of the invention;

FIG. 4 is a similar view to those of FIGS. 2 and 3 of a second embodiment of the invention;

FIG. 5 is similar view to those of FIGS. 2 to 4 of a third embodiment of the invention;

FIGS. 6A, 6B and 6C illustrate three stages of a method for producing an interior trim element according to the invention; and

FIG. 7 is a view similar to those of FIGS. 2 to 5 of a fourth embodiment of an interior trim element according to the invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

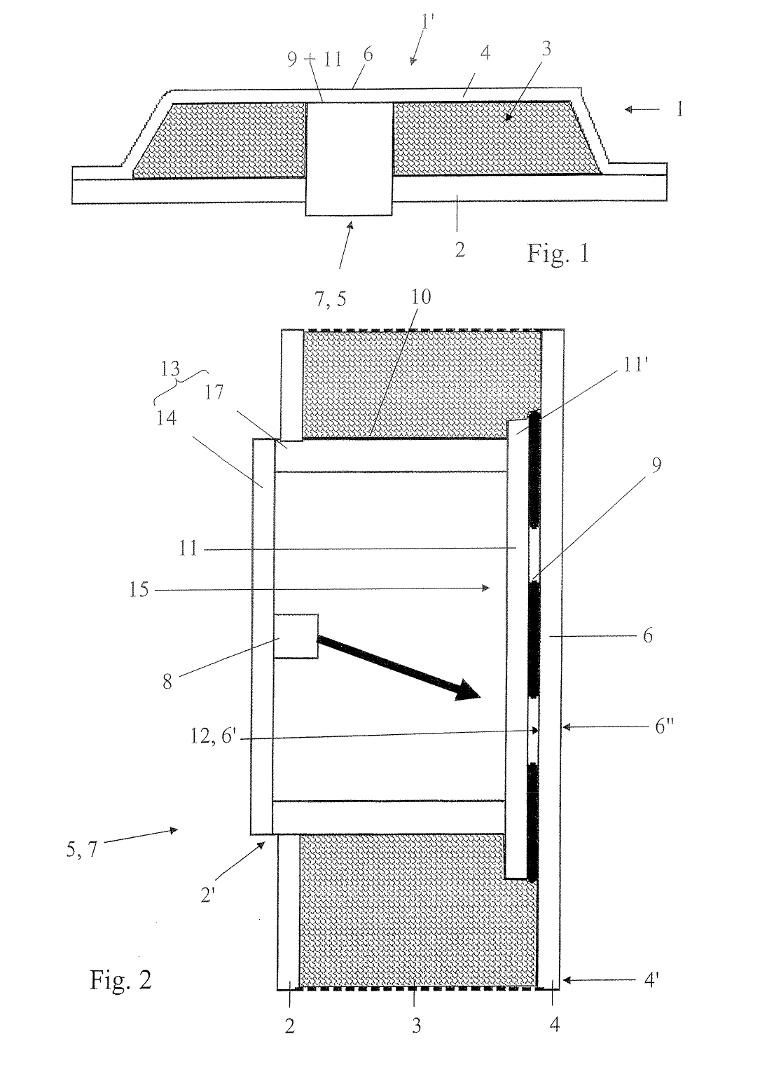

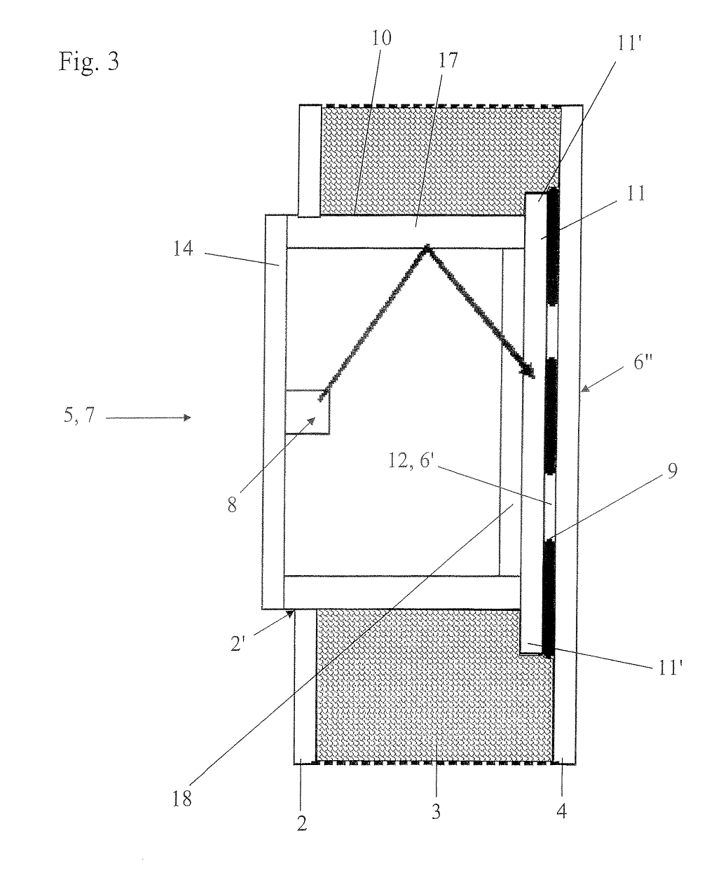

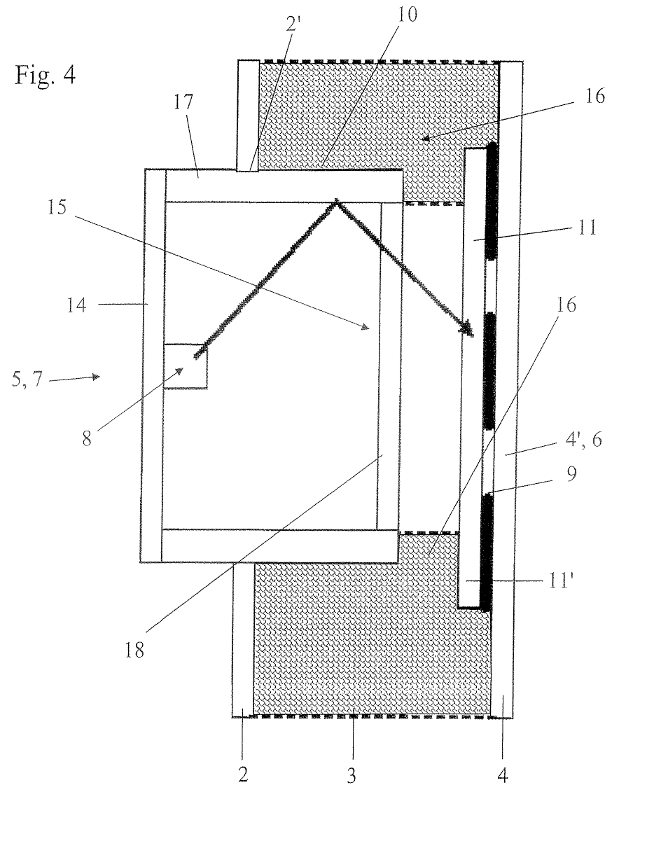

FIGS. 1 to 5 and 7 show an interior trim element 1, particularly for a motor vehicle, in particular for a dashboard of a motor vehicle, having a composite structure comprising a substantially rigid support substrate 2, a layer of intermediate material 3 with a specific thickness which extends over a surface part of at least one surface of the substrate 2 and a translucent or transparent covering skin 4 covering the visible surfaces of the intermediate layer of material 3 and the substrate 2.

The interior trim element 1 also integrates at least one device 5 for the selective display, on at least one continuous area 6 of the skin 4, of at least one piece of information, a symbol or similar visual object, this or each device 5 essentially comprising on the one hand a light box 7 integrating at least one light source 8, and on the other hand a facing 9 arranged so as to be illuminated by the light source 8, the projection of which is directed towards the corresponding associated display area 6 of the skin 4.

According to an embodiment of the invention, the light box 7 of the display device or of each display device 5 by projection is at least partly fitted into a corresponding receiving mount 10 arranged in the substrate 2 and in the layer of intermediate material 3 and extends up to the internal surface 6′ of the relevant display area 6 of the skin 4.

Furthermore, a sheet 11 of semi-rigid transparent or translucent material is applied directly or with the interposition of a facing 9 onto the internal face 6′ of the display area 6.

By means of these arrangements, a display zone 6 is formed with good optical qualities and good mechanical resistance (the sheet 11 functioning as a reinforcement). Moreover, the assembly of the unit forming the display device 5 is simple and makes it possible to obtain a close and solid integration of the different components of the device 5 in the interior trim element 1.

The degree of transparency of the covering skin 4 is such that the facing 9 and the visual object defined by the latter are not visible when the light source 8 is switched off, the non-visible or internal surface 6′ of the display area 6 being covered at least partly or in area(s) by a layer 12, which unifies the visual appearance of the visible surface 6″ of the display area 6 with the visual appearance of the visible surface 4′ of the rest of the covering skin 4.

The layer 12, which is applied for example by spraying, makes it possible to eliminate the contrast between white points or areas created by backlighting highly extended areas of skin 4 (during thermoforming for example), and the rest of the skin 4.

The skin 4 can be made from a thermoplastic material with an olefinic nature, polyvinyl chloride or polyurethane tinted in the mass or not tinted and produced by thermoforming (with the possible simultaneous formation of a particular aspect of the surface, for example with grains, grooves, and ribs), polyurethane molding, molding of powdered sludge or the like.

The material of the intermediate layer 3 is preferably polyurethane foam and the substrate 2 consists of a sheet of rigid material molded into shape or thermoformed. The sheet 11 can consist for example of a material of the polycarbonate or polyacrylate type.

According to one feature of the invention shown in FIGS. 2 to 5 and 6C, the light box 7 consists of a housing 13 with a base 14 supporting the light source or light sources 8, lateral walls 17 and an open face 15 opposite the base 14, the cross section of the housing 13 at its opening being adjusted to the contour of the facing 9 and/or of the display area 6, the lateral wall or walls 17 of the housing 13 being made from an opaque material reflecting or absorbing the light from the source 8 and forming with the base 14 an optically insulated chamber open only in the direction of the display area 6.

The semi-rigid sheet 11, possibly with the facing 9, is joined by close application to the internal surface 6′ of the area 6 of skin 4, for example by adhesion by means of an optical adhesive.

In one variant or in an additional manner, the sheet 11 can be supported at a peripheral lateral edge zone 11′ by the layer of intermediate material 3, for example in the form of cellular material made by molding by foaming in situ.

As shown in FIGS. 1 to 5 and 7 of the attached drawings, the structure of the light box 7 is such that the housing 13 bears, preferably under elastic tension, against the transparent or translucent semi-rigid sheet 11 either directly or with the interposition of a resilient layer 16, in particular a layer of foam or similar cellular material, applied to the free edges of the lateral walls 17 defining the opening of the housing 13 or forming part of the layer of intermediate material 3 and involved in supporting the sheet 11.

This latter arrangement makes it possible on the one hand to confer a certain flexibility by deformation or contraction to the pressure on the display area 6 and on the other hand to compensate for any play of the assembly, to ensure the optical tightness of the light box 7 at its interface with the sheet 11.

According to a first type of construction shown in FIGS. 2 to 4 of the attached drawings the facing 9 is sandwiched between the covering skin 4 and the transparent semi-rigid sheet 11, by being joined adhesively and closely to each of the latter.

Thus the housing 13 is fitted, substantially completely or at least largely, into the thickness of the intermediate layer 3.

In order to avoid points of high luminosity in the visual image displayed on the visible surface of the skin 4 and, in a more general manner, to unify the luminosity of the visual object produced by backlighting the facing 9 of the visible surface 6′ of the area of skin 6, a light diffusion sheet or layer 18 is provided between the light source or light sources 8 and the transparent semi-rigid sheet 11.

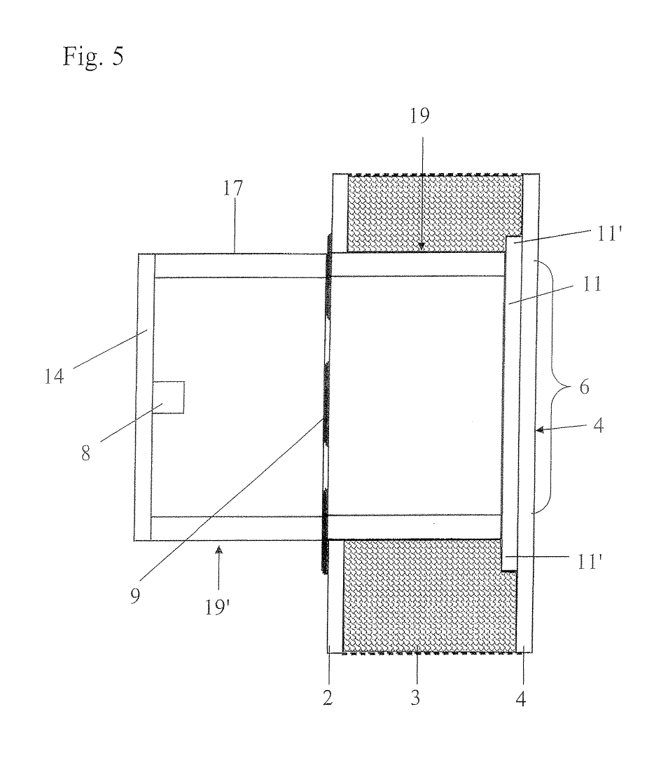

According to a second type of configuration of the invention shown in FIG. 5 of the attached drawings, the facing 9 is arranged at a distance from the transparent semi-rigid sheet 11 by being mounted in the housing 13 of the light box 7 at a distance from the light source or light sources 8, the housing 13 being formed by a first part 19 located in the mount 10 arranged in the substrate 2 and the layer of intermediate material 3 and opening into the display area 6 and a second part 19′ contiguous to the former, extending beyond the substrate 2 and including the light source or light sources 8, the facing 9 being applied to the traversing opening of the receiving mount 10 arranged in the substrate 2 and receiving by bearing the second part 19′ of the housing 13.

In order to obtain a secure connection of the light box 7 in the element 1, combined with the option of rapid assembly, which does not require an additional securing part or any special tool, the light box 7 is provided with means 20 for securing or locking in a mounted position, activated by elastic deformation or by interlocking, and connecting at the traversing opening 2′ of the receiving mount 10 arranged in the substrate 2.

According to one feature of the invention the light source or each light source 8 consists of one or more electroluminescent diode(s) mounted on an attached sheet, possibly in a removable manner, possibly a printed circuit board, forming the opaque base 14 of the light box 7, opposite the open surface 15 directed towards the display area 6, the internal volume of the housing 13 of the light box 7 being unitary or divided into at least two compartments 13′ each of which includes a light source 8 and is connected to a part of the facing 9.

This latter arrangement makes it possible to produce separate and independent displays of different signs by means of a single device 1.

According to an embodiment shown in FIG. 7 of the attached drawings, the light box 7 consists of a housing 13 with, on the one hand exterior lateral walls 17 provided with means 20 for securing or locking in mounted position, for example in the form of notches connecting with the opening edge 2′ of the traversing housing 10, arranged in the substrate 2, and on the other hand internal dividing walls 17′ defining at least two compartments 13′ each connected to a light source 8 and to a part of the specific facing 9 and each forming an independent optically insulated chamber.

In one method, the compartments 13′ are closed, in the direction of the display area 6, by the transparent or translucent semi-rigid sheet 11, supporting the facing 9, and on the opposite side by a sheet 14 forming the opaque base for the box 13 and holding the light sources 8.

Moreover, the housing 13 can also be provided with means 13″ for retaining the sheet 14 forming the base, bearing on or against the dividing walls 17′, in particular retaining means 13″ which are moveable by interlocking and/or elastic deformation and formed in a single piece with the internal and/or external walls 17, 17′, the semi-rigid sheet 11 being connected for example by adhesion, to the bearing zones and fixing zones 26 provided by extensions of the said walls 17, 17′.

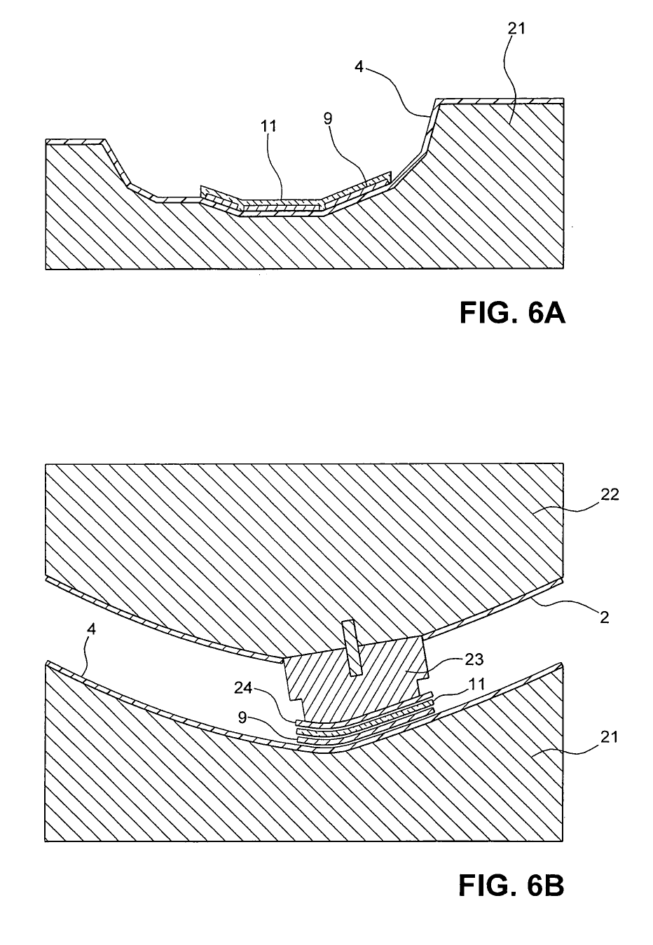

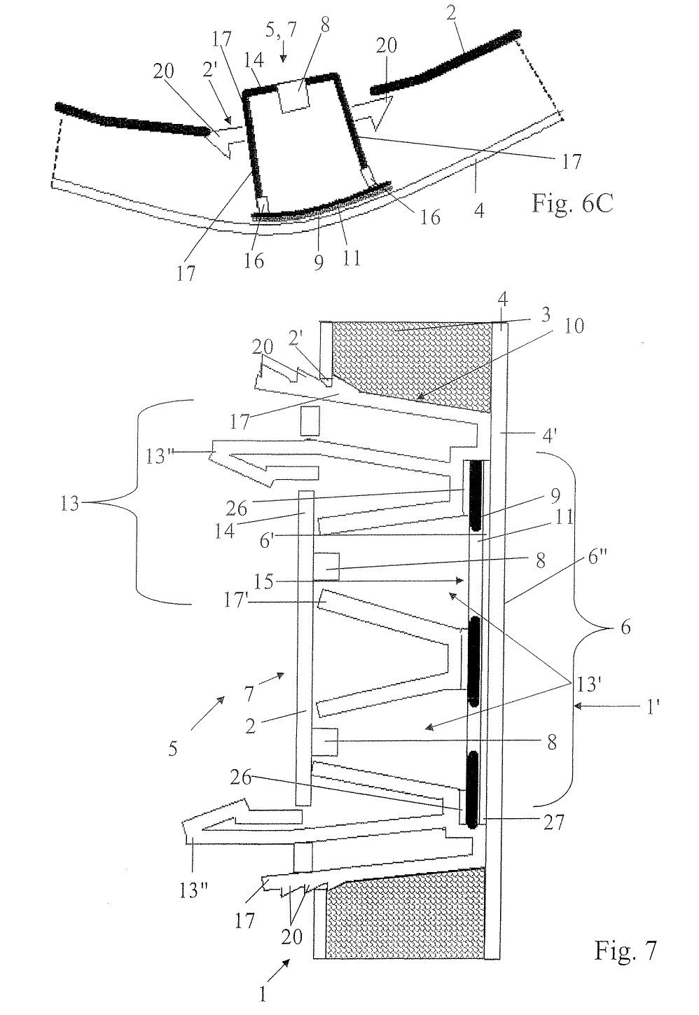

The subject matter of the present invention, as shown in FIGS. 6A, 6B and 6C illustrating an embodiment, is also a method for producing an interior trim element 1 as described above.

This method of production is essentially characterized in that it consists of producing a covering skin 4 with a shape corresponding substantially to the shape of the visible surface 1′ of the interior trim element 1 to the produced, arranging this skin 4 in the lower part 21 of a mold for foaming in situ, putting in place a facing 9 and a transparent or translucent semi-rigid sheet 11 supporting the facing 9, either at the level of an area 6 of skin 4 designed to form a display area, or at an insert 23 fixed onto an upper part 22 of the mold, putting in place in the part of the lower mold 21, or on the complementary part of the upper mold 22, a support substrate 2 in the form of a pre-shaped sheet and with at least one traversing opening 2′, closing the mold by closing the two parts 21 and 22, the upper part 22 being provided with one insert or the insert 23 which during closure passes through a corresponding opening 2′ arranged in the substrate 2 and comes to bear on the area 6 of the skin 4 on or by the semi-rigid transparent or translucent sheet 11, injecting a material or foaming mixture into the space between the skin 4 and the substrate 2, waiting for the end of the expansion and hardening of the foaming material, then opening the mold and removing the interior trim element 1 molded from the latter, and performing any necessary finishing operations for completing the assembly of the light box 7.

According to a first embodiment shown in FIGS. 6A to 6C of the attached drawings the assembly of the light box 7 consists of mounting the various components 14, 17, 17′ of the housing 13 of the light box 7 in the receiving mount 10 formed by the connection of the traversing opening 2′ of the substrate 2 and the volume liberated by the recess of the insert 23 in the layer of intermediate material 3 including the solidified foaming material, the joining of the facing 9 and the semi-rigid sheet 11 onto the internal surface 6′ of the display area 6 of the skin 4 being performed by adhesion by means of an optical adhesive 27, prior to closing the mold.

According to a second embodiment in relation to the interior trim element shown partly in FIG. 7, the insert 23 is formed by at least part of the light box 7 comprising the housing 13 provided with the semi-rigid sheet 11 bearing the facing 9 and, possibly the base sheet 14, a layer of optical adhesive 27 being applied onto the internal face 6′ of the display area 6 of the skin 4 prior to the closure of the mold, and the light source or light sources 8 being put in place, if need be with the base sheet 14, to complete the assembly of the light box 7 after the removal of the interior trim element 1 from the mold.

In this latter case the material of the layer 3 can be adhered closely onto the lateral external walls 17 of the housing 13 during foaming.

In an advantageous manner, the facing 9 can be formed by a cut-out in a sheet or a film of black opaque material, preferably adhesive on its two surfaces, said facing 9 being firstly laminated onto the transparent semi-rigid sheet 11, possibly pre-shaped according to the configuration of the corresponding display area 6 at the level of the covering skin 4, and the assembly [facing 9/sheet 11] being then applied to the internal surface 6′ of the display area 6, possibly with the interposition of an layer of optical adhesive 27, prior to the closure of the mold and the application of the insert 23.

In one variation, the facing 9 can also be formed by controlled depositing (for example by serigraphy) onto the sheet 11, which can be diffusing or non-diffusing.

In order to permit (within the scope of the embodiment shown by way of example in FIGS. 6A to 6C) the formation of the resilient layer 16 in the sheet, it is possible for the insert 23 defining the part of the receiving mount 10 formed in the layer of intermediate material 3 to be provided, at the contact face of its end 25 bearing closely and in a sealing manner on the transparent or translucent semi-rigid sheet 11, with a deformable, resilient or elastic layer 24, for example made of silicone, and at this end 25 to have a cross section, the circumference of which is smaller in dimension and set back in relation to the circumference of the said transparent or translucent semi-rigid sheet 11 so as to achieve the encapsulation of a peripheral edge zone 11′ by the foaming matter forming the intermediate layer 3 after hardening.

Furthermore, the method can consist of inserting a layer or sheet 18 for light diffusion between the light source 8 and the transparent or translucent semi-rigid sheet 11, on the open face 15 of the light box 7.

Moreover, the region of the internal face 6′ of the covering skin 4 corresponding to the display area 6 can be pre-treated, at least partially, by the application of a layer 12 which unifies the visual appearance of the visible surface 6″ of the display area 6 with the visual appearance of the visible face 4 of the rest of the covering skin 4.

In the following, the features and methods of obtaining at least some of the components forming the subject matter of the invention are described in more detail and by way of a non-restrictive example.

The skin 4 made of thermoplastic material may have a preliminary design for the definition of its color (coloring in the matter) and its properties of optical transmission.

If one wishes to form a display area or window 6 with a visible face 6″ which has a different surface appearance than the remaining part of the visible surface 4′ of the covering skin 4, it is possible either to treat the corresponding area locally with the thermoforming or molding tool, or to put in an insert adapted into the tool (indexed positioning of the insert—taking into account coefficient of retraction of the skin). A graining technique may be used to conceal any possible faults in the skin 4.

If the skin 4 is extended significantly during the thermoforming process, local white points or areas can appear which contrast with the main color of the translucent skin.

In order to prevent this contrast, a colored covering can be applied, for example by spraying, on the rear surface of the skin 4 after thermoforming. The color of the covering can be adjusted to obtain a homogenous color on the visible surface of the skin 4.

The facing 9 can be produced by using a sheet or film material which is opaque or black in color and having adhesive on its two opposite surfaces.

The thickness of the adhesive layers is typically less than 0.1 mm to avoid perception of handle on the visible surface of the skin 4, although other thicknesses can be used.

Once the facing 9 has been cut out from the sheet or film of material, it is laminated onto a semi-rigid sheet which is at least translucent (for example with a thickness of in the order of 0.5 mm). The sheet 11 has lateral dimensions greater that the area covered by the facing 9 (for example about 3 mm on each side), so as to form the edge area 11′ covered during the foaming.

The assembly [facing 9/sheet 11] is adhered to the internal surface 6′ of the skin 4 by the adhesive properties of the material forming the facing 9, without the addition of an additional adhesive agent. Of course, this assembly is adapted to the local shaping of the skin 4, the sheet 11 possibly being formed by molding, wherein the positioning is performed in a precise manner by an operator or a robot.

During the operation of shaping the intermediate layer 3 by foaming in situ, the facing is protected in a sealed manner. Therefore, an insert 23 is fixed to the upper part of the mold 22, so that on the closure of the mold, the facing is enclosed in a sealed manner between the skin 4 and the sheet 11, due to the bearing of the insert 23 on the sheet 11.

The insert 23 has a bearing surface covered with resilient material (for example silicone) and is treated on its outer surface to limit or avoid the adhesion of material forming the intermediate layer 3 at the time of releasing from the mold.

After the removal of the dashboard 1 from the mold 22, the latter will have a receiving mount 10 in the intermediate layer 3, delimited on the one hand in the direction of the skin 4, by the sheet 11 held peripherally against the skin by a band of material 16 formed by foaming at the time of producing the intermediate layer 3 and on the other hand in opposite direction by the opening 2′ arranged in the support substrate 2.

The light box 7 has a shape and dimensions adapted to the receiving mount 10. Its adjusted assembly with loading against the sheet 11 can be obtained by connecting means by elastic interlocking, such as tabs or hooks connecting with the edge of the opening 2′ of the substrate 2.

Furthermore, the light source or each light source 8 could be mounted by being fitted detachably (possibly by elastic interlocking, securing by screws, clips) into the wall of the base 14 of the housing 13.

The invention is not limited to the embodiments described and represented in the attached drawings. Modifications are still possible, in particular with regard to the configuration of the various elements or substituting equivalent techniques without departing as such from the scope of protection of the invention.

What is claimed is:

1. An interior trim element for a motor vehicle comprising:
a support substrate;
a layer of intermediate material extending over at least a surface of the substrate;
a covering skin covering visible surfaces of the layer of intermediate material and the substrate; and
a display device disposed adjacent the covering skin, the display device including a light box having a light source and a facing arranged so to be illuminated by the light source, wherein a projection of the facing is directed towards a display area of the skin to selectively display a visual object.

2. The interior trim element according to claim 1 further comprising a receiving mount disposed in the substrate and the layer of intermediate material, extending to an internal surface of the display area and adapted to receive the display device.

3. The interior trim element according to claim 1 further comprising a sheet formed from semi-rigid material having a desired transparency disposed adjacent the internal surface of the display area.

4. The interior trim element according to claim 1, wherein a degree of transparency of the covering skin is such that the facing and the visual object are not visible when the light source is switched off, an internal surface of the display area being covered at least partly by a layer uniting a visual appearance of a visible surface of the display area with a visual appearance of a visible surface of a remainder of the covering skin.

5. The interior trim element according to claim 1, wherein the light box includes a housing with a base supporting the light source, lateral walls, and an open face formed opposite the base, the lateral walls of the housing formed from an opaque material and forming with the base an optically insulated chamber open only in the direction of the display area.

6. The interior trim element according to claim 3, wherein the facing is sandwiched between the covering skin and the semi-rigid sheet.

7. The interior trim element according to claim 3, further including a light diffusion layer disposed between the light source and the semi-rigid sheet.

8. The interior trim element according to claim 2, wherein the facing is spaced from the semi-rigid sheet and mounted in the housing of the light box at a distance from the light source, the housing being formed by a first part located in the mount arranged in the substrate and the layer of intermediate material and opening into the display area, and a second part contiguous to the first part extending beyond the substrate and including the light source, the facing applied to a traversing opening of the receiving mount arranged in the substrate and receiving the second part of the housing.

9. The interior trim element according to claim 2, wherein the light box includes a means for securing the light box in a mounted position, the means for securing activated by at least one of an elastic deformation and an interlocking, and coupled at a traversing opening of the receiving mount arranged in the substrate.

10. The interior trim element according to claim 3, wherein the light source includes at least one electroluminescent diode mounted on an attached sheet forming the base of the light box, the diode mounted opposite the open surface and directed towards the display area, an internal volume of the housing of the light box having at least one compartment, the compartment coupled to at least a portion of the facing and including at least one light source.

11. The interior trim element according to claim 1, wherein the light box includes a housing having a plurality of exterior lateral walls including a means for securing the light box in mounted position, and a plurality of internal dividing walls defining at least two compartments each coupled to a light source and to at least a portion of the facing, wherein each compartment forms an independent optically insulated chamber.

12. The interior trim element according to claim 11, wherein the compartments are enclosed in a direction of the display area by the semi-rigid sheet, the semi-rigid sheet supporting the facing, and on the opposite side, the compartments are enclosed by a sheet forming the opaque base for the box and holding the light sources.

13. The interior trim element according to claim 12, wherein the housing includes a means for retaining the sheet forming the base, the means for retaining formed in a single piece with at least one of a plurality of internal walls and a plurality of external walls, the semi-rigid sheet being coupled to a plurality of bearing zones and a plurality of fixing zones provided by extensions of the internal walls and external walls.

14. An interior trim element for a motor vehicle comprising:
a support substrate;
a layer of intermediate material extending over at least a surface of the substrate;
a covering skin covering visible surfaces of the layer of intermediate material and the substrate;
a display device disposed adjacent the covering skin, the display device including a light box having a light source and a facing arranged so to be illuminated by the light source, wherein a projection of the facing is directed towards a display area of the skin to selectively display a visual object;
a receiving mount disposed in the substrate and the layer of intermediate material, extending to an internal surface of the display area and adapted to receive the display device; and
a sheet formed from semi-rigid material having a desired transparency disposed adjacent the internal surface of the display area.

15. The interior trim element according to claim 14, further including a light diffusion layer disposed between the light source and the semi-rigid sheet.

16. The interior trim element according to claim 14, wherein the facing is sandwiched between the covering skin and the semi-rigid sheet.

17. A method for producing an interior trim element for a dashboard of a motor vehicle, the method comprising the steps of:
providing a mold having a lower part and an upper part;
disposing a covering skin in the lower part of the mold;
disposing a facing and a semi-rigid sheet supporting the facing on at least one of a level of an area of the skin designed to form a display area and an insert fixed onto the upper part of the mold;
disposing a support substrate on at least one of the lower mold and the upper mold, the support substrate including a pre-shaped sheet having at least one traversing opening, closing the mold by closing the lower part and the upper part, the upper part including at least one insert which during closure passes through the corresponding opening in the substrate,
injecting an intermediate material into a space formed between the skin and the substrate;
opening the mold and removing the molded interior trim element; and
performing a finishing operation for completing the assembly of a light box including at least one light source and the facing arranged to be illuminated by the light source, wherein a projection of the facing is directed towards a display area of the skin.

18. The method according to claim 17, wherein the facing is formed by a cut-out in a sheet of black opaque material, the facing laminated on the semi-rigid sheet, and the assembly including the facing and the semi-rigid sheet applied to an internal surface of the display area prior to the closure of the mold and the application of the insert.

19. The method according to claim 17, further comprising the step of inserting a layer for light diffusion between the light source and the semi-rigid sheet.

20. The method according to claim 17, wherein a region of an internal face of the covering skin corresponding to the display area is at least partially pre-treated by an application of a layer which unifies a visual appearance of a visible face of the display area with a visual appearance of a visible face of a remainder of the covering skin.
